(19) United States
(12) Patent Application Publication
(10) Pub. No.: US 2015/0363403 A1
(43) Pub. Date: Dec. 17, 2015

(54) CONTEXTUAL SUGGESTIONS OF COMMUNICATION TARGETS

(71) Applicants: Dmitry Khalatov, Yokneam (IL); Sharone Zehavi, Karney Shomroh (IL)

(72) Inventors: Dmitry Khalatov, Yokneam (IL); Sharone Zehavi, Karney Shomroh (IL)

(21) Appl. No.: 14/305,241

(22) Filed: Jun. 16, 2014

(51) Int. Cl. G06F 17/30

(52) U.S. Cl. CPC G06F 17/3053; G06F 17/30321; G06F 17/30424

(57) ABSTRACT

The present disclosure involves systems, software, and computer implemented methods for providing contextual suggestions of communication targets. One example method includes identifying a communication, semantically analyzing the identified communication to identify at least one keyword or topic associated with the identified communication, comparing the identified at least one keyword or topic associated with the identified communication to a semantic index of communication targets associated with pre-defined keywords and topics, identifying a set of communication targets associated with the identified at least one keyword or topic associated with the identified communication, and presenting the identified set of communication targets as suggested communication targets. Presenting the identified set of communication targets as suggested communication targets may include ranking the identified set of communication targets based on at least one ranking parameter and identifying a subset of the relatively higher ranked communication targets.

### TECHNICAL FIELD

The present disclosure relates to computer-implemented methods, software, and systems for providing contextual suggestions of communication targets.

### BACKGROUND

Identifying experts in a particular field generally requires prior knowledge and contact lists, or a time-consuming search through previously-documented information. Experts needed for a particular subject may be within same organization of the person in need, or may be located external to the organization.

Semantic analysis of structured and unstructured data can provide distinct business and organizational advantages. Native and full-text searching can be used to create powerful data repositories providing links between persons, documents, and organizations, as well as analysis of those relationships. One example product including such semantic and text analyzers is SAP's HANA in-memory database solution.

### SUMMARY

The present disclosure involves systems, software, and computer implemented methods for providing contextual suggestions of communication targets. One example method includes identifying a communication, semantically analyzing the identified communication to identify at least one keyword or topic associated with the identified communication, comparing the identified at least one keyword or topic associated with the identified communication to a semantic index of communication targets associated with pre-defined keywords and topics, identifying a set of communication targets associated with the identified at least one keyword or topic associated with the identified communication, and presenting the identified set of communication targets as suggested communication targets. Presenting the identified set of communication targets as suggested communication targets may include ranking the identified set of communication targets based on at least one ranking parameter and identifying a subset of the relatively higher ranked communication targets.

While generally described as computer-implemented software embodied on tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for providing contextual suggestions of communication targets in a personal solution.

FIG. 2 is a block diagram illustrating an example system for providing contextual suggestions of communication targets in a social solution.

FIG. 3 is a block diagram illustrating an example system for providing contextual suggestions of communication targets in an enterprise solution.

FIG. 4 is a flowchart of an example method for identifying and providing contextual suggestions of communication targets.

FIG. 5 is a flowchart of an example method for generating indices for use in identifying contextual suggestions of communications targets.

### DETAILED DESCRIPTION

As part of their job, people are often required to solve problems requiring knowledge and expertise with which they may not be equipped. The typical way of dealing with such situations is to ask experts, or other individuals with more experience and know-how than themselves. If the problem occurs often enough, expert contact data can be easily remembered by individuals without the need for further searching. However, in situations where a problem has not been frequently experienced by the person, searching for a particular thread or conversation in a large communication archive (e.g., email, instant messaging (IM), phone records, etc.) may be complicated. Additionally, for situations where a person has not faced an issue before, there may not be any local communications archives that include information related to the solution, nor identifying particular experts who may be of assistance.

The present disclosure provides a solution to semantically index communication archives and create a ranked index associating individuals or particular contacts with topics and keywords based on an initial and on-going semantic analysis of communications. Connections between particular topics and keywords and specific contacts can be based on a regularity of communications with a particular person on a particular topic or using a particular keyword, an average length of a communication associated with the topic/keyword, the number of messages in a thread or communications in a conversation associated with the topic/keyword, as well as other bases. The connections between contacts and keywords can be stored in a semantic index available to be leveraged by users when searching for such expertise. Explicit and implicit user feedback can be employed to update and modify the connections, as appropriate. Implicit user feedback may be received in response to prior suggestions: that is, when a suggestion is selected and used, the relative strength of the corresponding association of the suggested contact to the topic/keyword may be increased. If the suggestion is not used, the strength may be when contacts are selected in prior suggestions, the strength may be decreased. Explicit user feedback may be provided by responses to the systems by users explicitly identifying a contact as an expert on a topic/keyword, or by users explicitly clarifying that a particular contact is not an expert on a topic/keyword.

When a particular topic or keyword is identified as associated with a current communication, such as a question from an associate regarding a particular topic, the present solution can generate a list of potential contacts with identified expertise in a subject. That list can then be ranked according to one or more parameters, including organizational data, user feedback, user location, and user relationships, as well as any other suitable parameters. In some instances, particularly where a plurality of contacts are included in the list, only a subset of those identified may be returned to the user.

The disclosed solution can be executed in any suitable environment, including a single client system, a social system in which users can share information to provide and enhance suggestions voluntarily, and an enterprise system, where information from users within an organization can be shared and used to determine appropriate experts or communication targets based on a shared knowledgebase across the organization. Other suitable environments may also be used to employ the solution. The solution can be implemented as a communication client plug-in, as part of the functionality of a communication application, a standalone application, or as a web service.

As an example situation, an employee may receive an email from a co-worker related to issues with the co-worker's mouse. The receiving employee may not have the IT knowledge needed to provide adequate support for the issue, and may wish to identify another contact that may be able to assist. Normally, the receiving employee would consider who in the office may be of help, and can forward the message accordingly. Using the tools described herein, the receiving employee can automatically have one or more contact suggestions presented to him based upon an automatic contextual analysis of the received email to identify keywords and topics associated with the communication. Those keywords and topics can then be compared to a corresponding semantic index associating a plurality of keywords and topics with one or more contacts to identifying an appropriate suggestion. In some instances, the contacts associated with the keyword or topic can be ranked based on any number of suitable parameters. As described, the semantic index can be based on the employee's prior communications, documents, and other available information to establish and identify contacts associated with particular topics. In some instances, the experience of other employees and persons may be incorporated into a social or enterprise semantic index, allowing a crowd-surfed suggestion set to be presented. In some instances, both explicit and implicit user feedback can be incorporated into the ranking and associations for the solution, such that associations and relative rankings can be modified as persons use it. Additionally, other external information can be used to assist in ranking the results of the comparison, including organizational charts, social relationships, user location and time zones, among others.

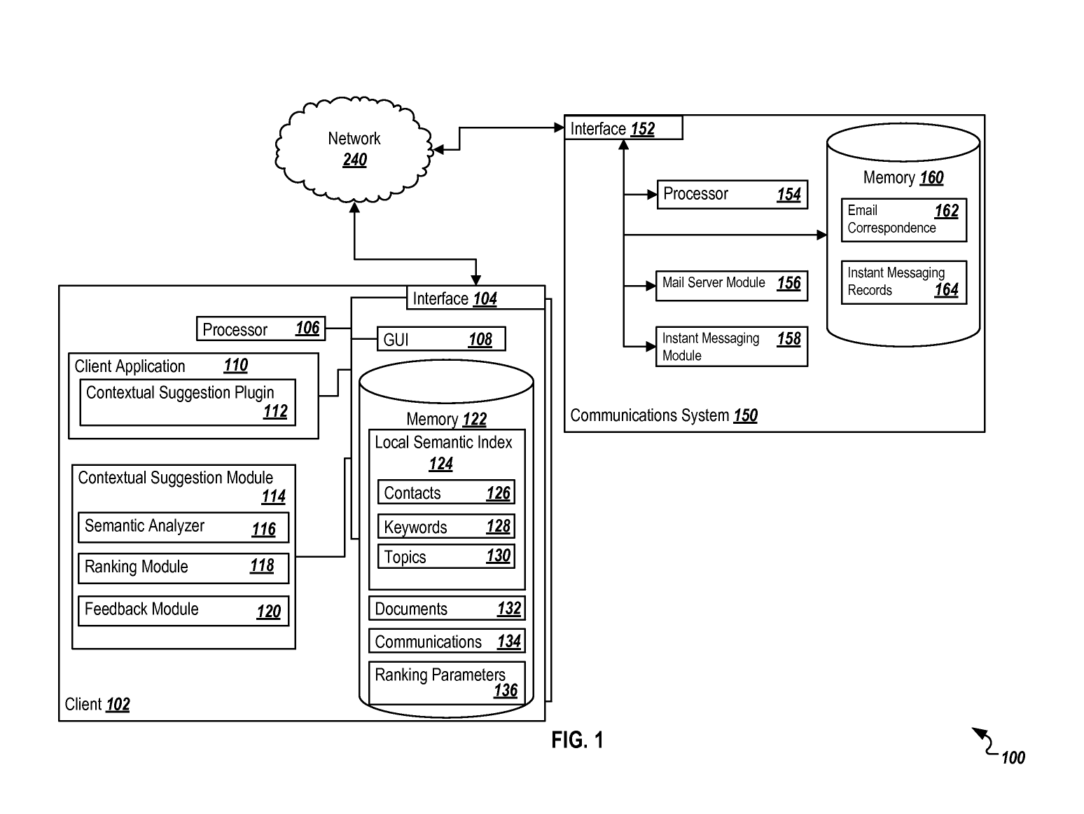

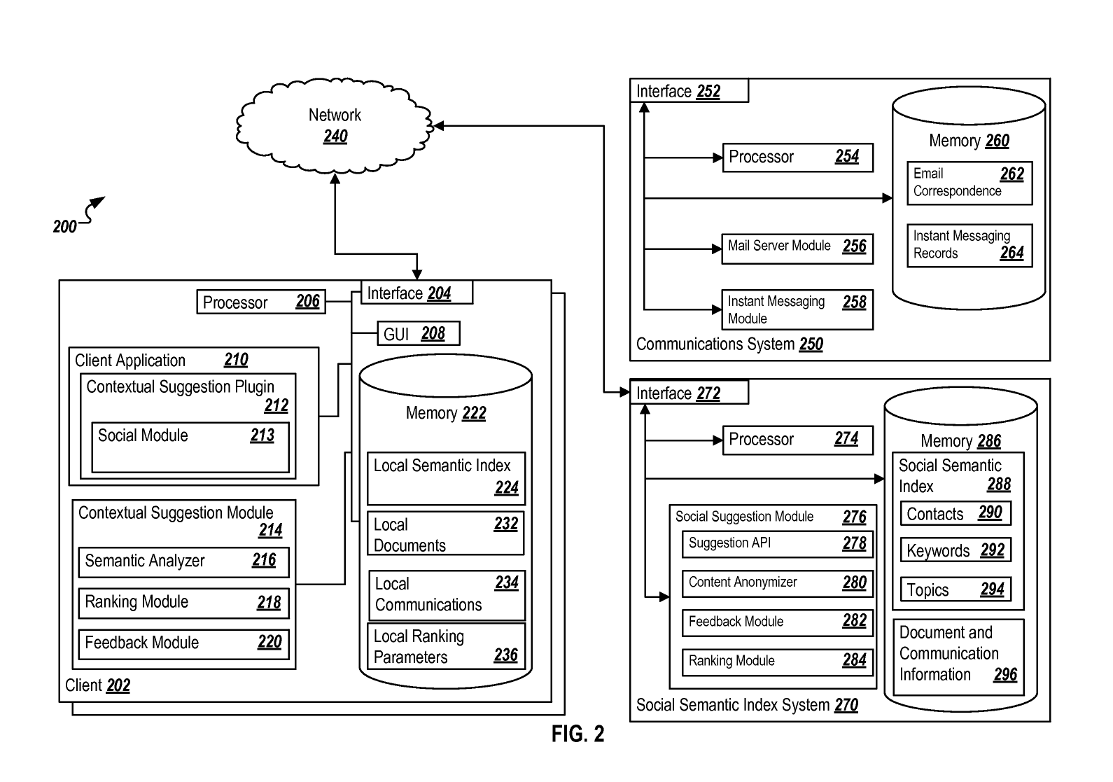

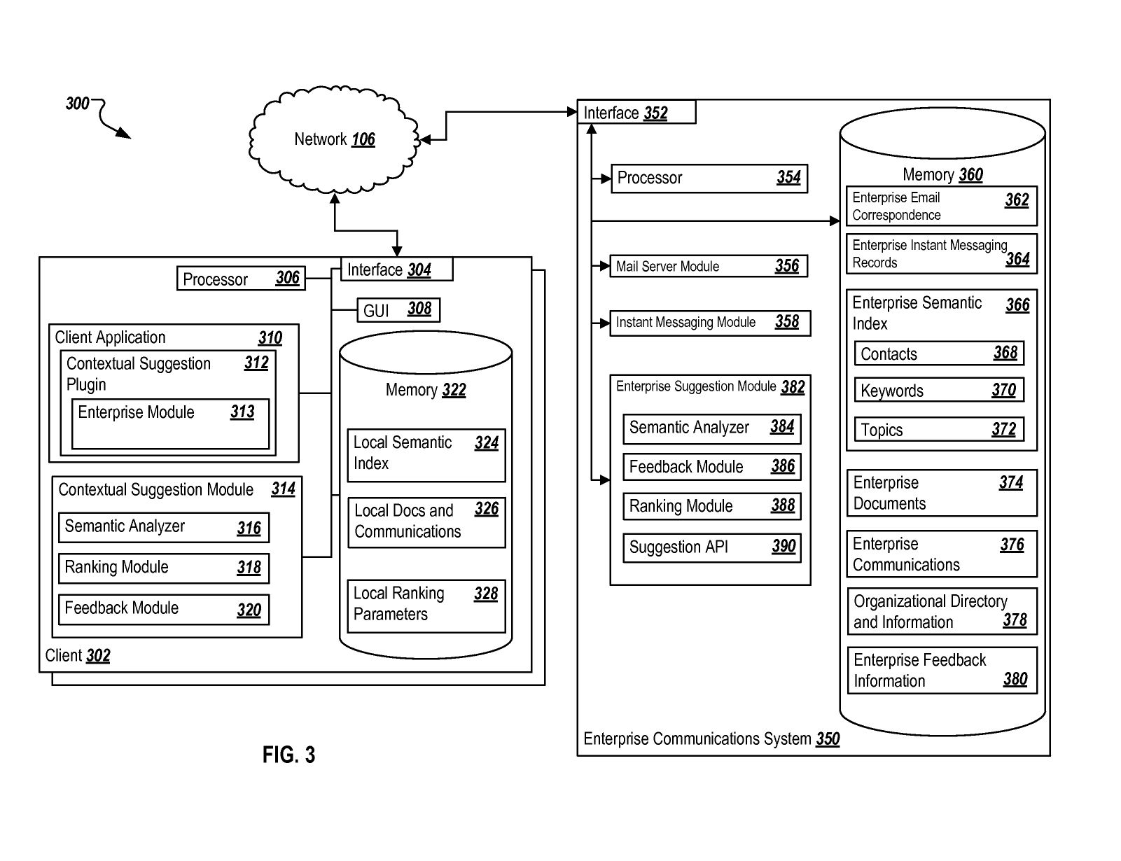

FIG. 1 is a block diagram illustrating an example system for providing contextual suggestions of communication targets in a personal solution. FIG. 2 illustrates an example system in a social solution, while FIG. 3 illustrates an example system in an enterprise solution. The discussion of FIGS. 2 and 3 will focus on the differences with FIG. 1's personal solution. In each illustration, although components are shown individually, in some implementations, functionality of two or more components, systems, or servers may be provided by a single component, system, or server. Similarly, in some implementations the functionality of one illustrated component, system, or server may be provided by multiple components, systems, or servers.

As illustrated in FIG. 1, system 100 includes or is communicably coupled with a client 102, a network 140, and a communications system 150. The client 102 may be any computing device operable to connect to or communicate with at least the communications system 150 via the network 140 using a wireline or wireless connection. In general, the client 102 comprises an electronic computer device operable to receive, transmit, process, and store any appropriate data associated with the environment 100 of FIG. 1. Client 102 executes a client application 110 associated with one or more communications and/or documents owned by or associated with a user of the client 102.

The illustrated client 102 includes an interface 104, a processor 106, a graphical user interface (GUI) 108, the client application 110, a contextual suggestion module 114, and a memory 122. The interface 104 is used by the client 102 for communicating with other systems in a distributed environment—including within the environment 100—connected to the network 140; for example, the communications system 150, as well as other systems communicably coupled to the network 140 (not illustrated). Generally, the interface 104 comprises logic encoded in software and/or hardware in a suitable combination and operable to communicate with the network 140. More specifically, the interface 104 may comprise software supporting one or more communication protocols associated with communications such that the network 140 or interface's hardware is operable to communicate physical signals within and outside of the illustrated environment 100.

As illustrated in FIG. 1, the client 102 includes a processor 106. Although illustrated as a single processor 106 in FIG. 1, two or more processors may be used according to particular needs, desires, or particular implementations of the environment 100. Each processor 106 may be a central processing unit (CPU), an application specific integrated circuit (ASIC), a field-programmable gate array (FPGA), or another suitable component. Generally, the processor 106 executes instructions and manipulates data to perform the operations of the client 102. Specifically, the processor 106 executes the functionality required to execute the client 102 generally, as well as the client application 110 and the contextual suggestion module 114, including the functionality for sending and receiving communications to and from the communications system 150.

Further, the illustrated client 102 includes a graphical user interface (GUI) 108. The GUI 108 interfaces with at least a portion of the environment 100 for any suitable purpose, including generating a visual representation of a Web browser and/or the client application 110. In particular, the GUI 108 may be used to view and navigate various Web pages located both internally and externally to environment 100, as well as to view and navigate through various communications associated with the client application 110. The GUI 108 associated with each client 102 may comprise a graphical user interface operable to, for example, allow the user of a client 102 to interface with at least a portion of the contextual suggestion module 114 and its associated operations and functionality, as well as other applications. In FIGS. 2 and 3, for example, the corresponding GUIs 208 and 308 may be used to visualize portions of a social semantic index system 270 and an enterprise communications system 350, respectively. Generally, the GUI 108 provides the particular user with an efficient and user-friendly presentation of business data provided by or communicated within the system. The GUI 108 may comprise a plurality of customizable frames or views having interactive fields, pull-down lists, and buttons operated by the user. For example, the GUI 108 may provide interactive elements that allow a user to select particular suggested contacts in relation to a particular issue, topic, and/or communication. The GUI 108 may include interactive portions associated with those suggested contacts, such that when a user clicks, touches, or otherwise interacts with a particular suggested contact, that particular suggested contact is added to a TO: field in a communication such as an email or instant message, among others. Generally, the GUI 108 may also provide general interactive elements that allow a user to access and utilize various services and functions of a particular client application 110. The GUI 108 may present information associated with the client application 110 for viewing and interaction. In general, the GUI 108 is often configurable, supports a combination of tables and graphs (bar, line, pie, status dials, etc.), and is able to build real-time portals, where tabs are delineated by key characteristics (e.g., site or micro-site). Therefore, the GUI 108 contemplates any suitable graphical user interface, such as a combination of a generic web browser, intelligent engine, and command line interface (CLI) that processes information in the platform and efficiently presents the results to the user visually.

The illustrated client 102 also includes memory 122, or multiple memories 122. The memory 122 may include any memory or database module and may take the form of volatile or non-volatile memory including, without limitation, magnetic media, optical media, random access memory (RAM), read-only memory (ROM), removable media, or any other suitable local or remote memory component. The memory 122 may store various objects or data, including caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the client 102. Additionally, the memory 122 may include any other appropriate data, such as VPN applications, firmware logs and policies, firewall policies, a security or access log, print or other reporting files, as well as others. In some instances, memory 122 can store information associated with one or more documents 132 and communications 134. The documents 132 may be any documents capable of being analyzed by a semantic analyzer 116. The communications 134 may be any suitable communications, including but not limited to emails, instant messages, texts, transcribed or non-transcribed voice messages, contacts, as well as other suitable communications. The documents 132 and communications 134 may be directly associated with the client application 110 or they may be unrelated.

Memory 122 further includes a local semantic index 124. The local semantic index 124 comprises a semantic index associating one or more contacts 126 with various keywords 128 and topics 130 based on various semantic analyses. In general, the local semantic index 124 is generated through a semantic analysis of the various documents 132 and communications 134 on the client 102. Based on the various data and metadata associated with these documents, the semantic index's associations are generated. The semantic index 124 can be initially generated based on a collection of documents 132 and communications 134 at a particular time in instances where the functionality is added to an existing client 102. Updating of the semantic index 124 can occur on a regular or periodic basis, as well as in response to identifying new documents 132 and/or communications 134—e.g., in response to their generation, receipt, or sending. In some instances, additional indexing may be delayed until a particular number of new documents 132 and/or communications 134 are identified for indexing. When the functionality is added before any documents 132 and communications 134 are available, the semantic index 124 can be generated over time as documents and communications are generated, received, and sent. The illustrated ranking parameters 136 may comprise a set of rules determining how the semantic analysis is to weigh particular attributes, connections, data, and metadata associated with each document 132 or communication 134, and how those factors strengthen or weaken a particular association between a contact 126 and one or more keywords 128 or topics 130.

The illustrated client 102 further includes the client application 110. The client application 110 is any type of application that allows the client 102 to communicate with one or more other persons or entities. In some instances, the client application 110 may be an email application, an instant messaging application, a Voice Over IP (VOIP) application, a web browser executing a communications application, or any other suitable communications application. The client application 110 can, in general, provide messaging and/or communication functionality to the client 102.

As illustrated, the client application 110 includes a contextual suggestion plug-in 112 to provide suggestions in response to an identified communication. The contextual suggestion plug-in 112 can communicate with the contextual suggestion module 114 to identify one or more keywords and topics associated with a particular communication, and to present one or more suggested communication targets or contacts associated with those keywords or topics. In some instances, viewing a particular communication (e.g., an email or instant message) can trigger use of the contextual suggestion plug-in 112. In other instances, attempting to forward a particular communication can trigger the contextual suggestion. In still other instances, a semantic analysis can be triggered on a new communication based on an analysis of the content of that new communication prior to its sending. The contextual suggestion plug-in 112 can be triggered automatically (e.g., based on any of the above actions) or triggered in response to a manual request. In some instances, the manual request may be triggered by the activation of a “suggestion” button presented in or around the visual interface of the corresponding client application 110.

The contextual suggestion plug-in 112 can share information associated with the identified communication to the contextual suggestion module 114 (including, in some instances, the communication itself), where the contextual suggestion module 114 semantically analyzes the identified communication (e.g., using the semantic analyzer 116) to identify one or more keywords or topics associated with the communication. Once the keywords or topics are identified, the contextual suggestion module 114 can identify, via the ranking module 118, one or more contacts 126 in the local semantic index 124 associated with the identified keywords and topics of the identified communication. The ranking module 118 can identify strengths of the connections between the one or more contacts 126 based, in part, on the ranking parameters 136, as well as other parameters, including those identified by users. In some instances, the associations between contacts 126 and the keywords 128 and topics 130 may provide or identify relative indications of strength within the local semantic index 124. During generation of the index 124, for instance, the frequency of communications or documents related to a particular topic or keyword and to a particular contact may be considered (i.e., how often a particular person is associated with a particular topic) in determining the strength of an association. That is, where the user has previously contacted a particular contact regarding a particular topic may be used in making an association stronger in the semantic index 124. Additional considerations and parameters used in ranking contacts 126 may include information defined in an organizational structure of the company, including particular roles in the organization, persons having similar managers as the user, relative locations of the contacts, both within the same office and/or within a similar time zone. Regarding the time zone consideration, contacts may be ranked higher where they are currently in a time zone within current working hour. For example, a user who needs assistance after hours in New York may find a California contact more desirable than one also in New York. Availability or recent activity on instant messaging or email may also raise the rank of contacts. In some instances, the semantic index 124 itself may consider these parameters, while in other instances, at least some of the parameters may be used by the ranking module 118 to adjust the rankings of contacts 126 at the time of the request for a suggestion and outside of the semantic index 124. The ranking module 118 may also manage the number of suggested contacts returned in a particular situation. In some instances, for example, only the three to five highest-ranked contacts 126 may be included in a particular suggestion, where a larger number of contacts 126 are associated with the keyword 128 or topic 130.

The contextual suggestion module 114 includes a feedback module 120. The feedback module 120 can provide a feedback mechanism for further updating the semantic index 124. In some instances, users can provide information confirming particular contacts, including themselves, as experts or otherwise associated with particular keywords or topics. Based on this feedback, the association in the semantic index 124 can be strengthened accordingly. Conversely, explicit feedback can be provided to indicate that a particular contact, including themselves, should not be connected to a particular topic or keyword. Associations between contacts and particular keywords and topics can also be based on information retrieved from one or more social networks. Additionally, the feedback module 120 can update associations based on indirect feedback identified during interactions. For example, the selection of a particular suggested contact from a larger set may provide feedback to the system to strengthen the association between the selected contact and the current keyword or topic. Similarly, the non-selection of a particular suggested contact can weaken the association or relative ranking of the contact with the keyword or topic.

When a particular suggestion is selected, the client application 110 can add that selected contact into the To: line of a forwarded email, initiate an instant message to the selected contact, or perform any other suitable interaction.

There may be any number of clients 102 associated with, or external to, the environment 100. For example, while the illustrated environment 100 includes one client 102, alternative implementations of the environment 100 may include multiple clients 102 communicably coupled to the communications systems 150 and/or the network 140, or any other number suitable to the purposes of the environment 100. Additionally, there may also be one or more additional clients 102 external to the illustrated portion of environment 100 that are capable of interacting with the environment 100 via the network 140. Further, the term “client” and “user” may be used interchangeably as appropriate without departing from the scope of this disclosure. Moreover, while the client 102 is described in terms of being used by a single user, this disclosure contemplates that many users may use one computer, or that one user may use multiple computers.

The illustrated client 102 is intended to encompass any computing device such as a desktop computer, laptop/notebook computer, wireless data port, smart phone, personal data assistant (PDA), tablet computing device, one or more processors within these devices, or any other suitable processing device. For example, the client 102 may comprise a computer that includes an input device, such as a keypad, touch screen, or other device that can accept user information, and an output device that conveys information associated with the operation of the client application 110 or the client 102 itself, including digital data, visual information, or a GUI 108, as shown with respect to the client 102.

Network 140 facilitates wireless or wireline communications between the components of the environment 100 (i.e., between the client 102 and the communications system 150), as well as with any other local or remote computer, such as additional clients, servers, or other devices communicably coupled to network 140, including those not illustrated in FIG. 1. In the illustrated environment, the network 140 is depicted as a single network, but may be comprised of more than one network without departing from the scope of this disclosure, so long as at least a portion of the network 140 may facilitate communications between senders and recipients. In some instances, one or more of the illustrated components associated with the contextual suggestion module 114 and the semantic index 124 may be included within network 140 as one or more cloud-based services or operations. The network 140 may be all or a portion of an enterprise or secured network, while in another instance, at least a portion of the network 140 may represent a connection to the Internet. In some instances, a portion of the network 140 may be a virtual private network (VPN). Further, all or a portion of the network 140 can comprise either a wireline or wireless link. Example wireless links may include 802.11a/b/g/n, 802.20, WiMax, LTE, and/or any other appropriate wireless link. In other words, the network 140 encompasses any internal or external network, networks, sub-network, or combination thereof operable to facilitate communications between various computing components inside and outside the illustrated environment 100. The network 140 may communicate, for example, Internet Protocol (IP) packets, Frame Relay frames, Asynchronous Transfer Mode (ATM) cells, voice, video, data, and other suitable information between network addresses. The network 140 may also include one or more local area networks (LANs), radio access networks (RANs), metropolitan area networks (MANs), wide area networks (WANs), all or a portion of the Internet, and/or any other communication system or systems at one or more locations.

The communication system 150 includes interface 152, processor 154, mail server module 156, instant messaging module 158, and memory 160. In general, the communication system 150 is a simplified representation of one or more communication systems associated with the client 102 and its client application 110. Interface 152 and processor 154 may be similar to interface 104 and processor 106. The mail server module 156 may be a program or application supporting a client- or web-based email system, while the instant messaging module 158 can provide instant messaging capabilities to the client 102 and other clients or systems. In some implementations, one or both of the mail server module 156 and instant messaging module 158 may be absent. Memory 160 may be similar to memory 122, and is illustrated as including email correspondence 162 and instant messaging records 164. These may be an enterprise store, a web-based store, or any other suitable storage of communications.

At a high level, the communications system 150 comprises one or more electronic computing devices operable to receive, transmit, process, store, or manage data and information associated with the environment 100 and, in particular, communication-related information. Specifically, the communication system 150 illustrated in FIG. 1 is responsible for supporting communication within the environment. The communication system 150, while illustrated as a single system, may be represented as a plurality of systems and servers performing communication-related functionality. In some instances, the communication system 150 may further store one or more cloud-based documents that can also be used in generating and evaluating the local semantic index 124 at client 102.

As used in the present disclosure, the term “computer” is intended to encompass any suitable processing device. For example, although FIG. 1 illustrates a single communication system 150, environment 100 can be implemented using two or more such systems, as well as computers other than servers, including a server pool. Indeed, communication system 150 may be any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, illustrated client 102 and communication system 150 may be adapted to execute any operating system, including Linux, UNIX, Windows, Mac OS®, Java™, Android™, iOS or any other suitable operating system. According to one implementation, communication system 150 may also include or be communicably coupled with an e-mail server, a Web server, a caching server, a streaming data server, and/or other suitable server or computer.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, JavaScript, Java™, Visual Basic, assembler, Perl®, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

Turning to FIG. 2, a block diagram illustrating an example system 200 for providing contextual suggestions of communication targets in a social solution is provided. Many of the components of the social system 200 are similar to those in the personal system 100. Those components will not be described again herein, but can instead be compared to the descriptions of FIG. 1 for context.

In the social solution, users can voluntarily share information related to their local semantic indices 224 with a plurality of other users, in order to provide a larger pool of information and potentially stronger suggestions based on the larger data set. As illustrated, client 202 is generally similar to client 102 of FIG. 1. The contextual suggestion plug-in 212 includes a social module 213, where the social module 213 can connect to and share information from and with the social semantic index system 270.

The social semantic index system 270 can include interface 272, processor 274, social suggestion module 276, and memory 286. Interface 272 and processor 274 can be similar to the previously discussed interfaces and processors, and can provide access to network 240 and execute functionality on the system 270, respectively. The social suggestion module 276 provides similar functionality to the local contextual suggestion module 214 (similar to contextual suggestion module 114), and allows remote users, via the social module 213 and contextual suggestion plug-in 212, to receive suggestion contacts associated with an identified communication. A suggestion application programming interface (API) 278 provides an interface to the social suggestion module 276 to the one or more clients 202. A content anonymizer 280 removes any protected, confidential, or sensitive information from information being sent to or received at the social semantic index system 270. The content anonymizer 280 can anonymize certain portions of the information shared with the social semantic index system 270 to provide enhanced data security and privacy. In some instances, the content anonymizer 280, or a related component, may be located at the client 202 (e.g., within the social module 213) to prevent sensitive information from being shared with the social semantic index system 270.

The social suggestion module 276 can include a feedback module 282 and a ranking module 284 similar to the local contextual suggestion module 214. As illustrated in FIG. 2, the semantic analyzer 216 (similar to semantic analyzer 116 of FIG. 1) is located at the client 202. In some instances, the social semantic index system 270 and its social suggestion module 276 may also include a semantic analyzer to perform analyses at the social semantic index system 270. In the illustrated example, individual communications can be semantically analyzed at the client 202, with relevant information being sent to social semantic index system 270 for further analysis. This can avoid the need to share specific communications or documents over the network 240, instead allowing the social module 213 and contextual suggestion plug-in 212 to only share any keywords or topics extracted from an identified communication.

The social semantic index system 270 includes memory 286, where a social semantic index 288 is stored. The social semantic index 288 can be similar to the local semantic index 224, but with a combined set of information from a plurality of users. The social semantic index 224 can include multiple contacts 290 associated with a plurality of keywords 292 and topics 294. Additionally, some document and communication information 296 derived from the underlying documents 232 and communications 234 may be stored in memory 286. As illustrated, the client 202 may retain a local semantic index 224 for local processing, even where the social semantic index system 270 is available. This can provide backup functionality when the network connection is unavailable, where certain identified communications may be too sensitive to share even anonymized information, or in other situations where a local solution may be more practical or required.

FIG. 3 is a block diagram illustrating an example system 300 for providing contextual suggestions of communication targets in an enterprise solution. In an enterprise solution, an organization can share communications and documents into a common enterprise semantic index to provide detailed document and communication information in one location, thereby greatly benefiting the organization in identifying the true experts associated with particular topics and keywords. In enterprise solutions, the information may or may not by anonymized. However, some filters may be put in place to avoid providing suggestions related to sensitive or private information. For example, a filter may prevent users from generating an email related to layoffs or specific confidential dealings, requesting a suggested contact, and getting privileged or highly confidential information on contacts with relevant information. Such filters can be defined by members of the organization's IT department, business leaders, attorneys, or other suitable persons.

Client 302 is similar to the client 102, and may include a local semantic index 324 for similar reasons as described with regard to the local semantic index 224 in the social solution. In FIG. 3, the contextual suggestion plug-in 312 may include an enterprise module 313, which provides a connection to the suggestion API 390 within the enterprise suggestion module 382. As illustrated, the enterprise communications system 350 may include a mail server module 356 and instant messaging module 358, as well as any other suitable communication tools or functionality.

The enterprise communication system 350 includes interface 352, processor 354, mail server module 356, instant message module 358, enterprise suggestion module 382, and memory 360. The interface 352 may be similar to interfaces 152, 252, and processor 354 may be similar to processors 154, 254. The enterprise suggestion module 382 provides enterprise-level suggestion functionality, and includes a semantic analyzer 384, a feedback module 386, a ranking module 388, and the suggestion API 390. The semantic analyzer 384 may take the place of or supplement the semantic analyzer 316 at the client 302. Because some or all of the communications in the enterprise solution may flow through the enterprise communication system 350, the relevant enterprise documents 374 and enterprise communications 376 may be available to analyze at the enterprise communication system 350. The suggestion API 390 may be similar to the suggestion API 278 of the social solution, in that the API 390 provides an interface to the relevant functionality. The feedback module 386 and the ranking module 388 may be similar to those previously described, with the exception that the ranking module 388 may use an organizational directory and organization information 378 to assist in the ranking and analysis process. This information 378 can be used to identify specific roles and responsibilities within the enterprise—if a user has a question related to IT, the organizational information 378 can be used to identify an IT employee to forward the issue.

Memory 360 may be similar to the memories of the previously-described solutions, and can include the enterprise email correspondence 362 and instant messaging records 364, the enterprise semantic index 366, the enterprise documents 374 and communications 376, the organizational information 378, and enterprise feedback information 380.

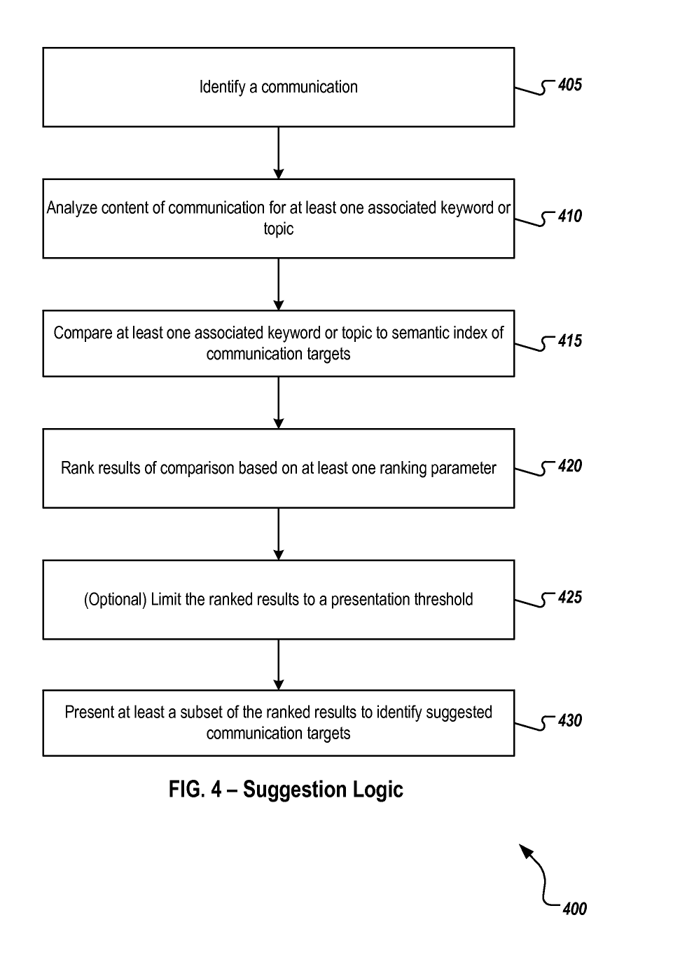

FIG. 4 is a flowchart of an example method 400 for identifying and providing contextual suggestions of communication targets. For clarity of presentation, the description that follows generally describes method 400 in the context of FIGS. 1 through 3. However, it will be understood that method 400 may be performed, for example, by any other suitable system, environment, software, and hardware, or a combination of systems, environments, software, and hardware as appropriate.

At 405, a communication is identified. In some instances, the identified communication may be an email message, an instant message, a short messaging service (SMS) message, or any other suitable communication. Identification of the identification may occur at the time of receipt, when action (e.g., forwarding, reply, reading) is taken on a prior communication, or when a new communication is being prepared

At 410, content of the identified communication can be semantically analyzed for at least one keyword or topic associated with the identified communication. In addition to content, metadata associated with the identified communication can be considered in the analysis. The semantic analysis can be performed locally at a client, remotely using a web service, at an enterprise server, or any suitable location. The semantic analysis usually results in one or more keywords or topics associated with the identified communication. In some instances, additional user information or metadata can be used to further classify the identified communication. The additional information can identify the sender of a communication, and can further classify the identified communication based on the sender, the sender's role within an organization, prior conversations or communications with the sender, one or more other persons' interactions with the sender (e.g., where information with other users is shared with the current user), or on information about the sender provided by the current user, other users, or the sender himself.

The at least one keyword or topic associated with the identified communication can then be compared to one or more pre-defined keywords and topics included in a semantic index at 415. As described above, the semantic index includes a plurality of keywords and topics identified during a semantic analysis of prior communications, interactions, and other information, and associates those keywords and topics to one or more contacts. These contacts, whether persons, mailing lists, or entities, comprise potential communications targets which can be suggested to the current user. One or more potential suggested contacts can be identified based on the comparison of 415.

At 420, the results of the comparison between the keywords and topics associated with the identified communication and the semantic index (i.e., the contacts associated with the identified keywords and topics) can be ranked based on at least one ranking parameter. In some instances, the relative associations of the contacts in the semantic index to the keywords and topics may vary in strength, providing initial (and in some instances, ongoing via feedback) rankings. In those instances, the rankings can be modified based on one or more real-time or user-related parameters. These parameters may include a comparison of the contact to the location of the current user. In some instances, this comparison may include not only a physical location per se of the current user and the potential suggestion, but also whether the potential suggestion is currently available to assist. This may include whether the current time zone of the suggested contact is at a normal working hour, as well as whether the suggested contact is recently and/or is currently available via one or more communication channels. The ranking may further take into consideration various other considerations, including organizational information. For example, the organizational structure of an organization may be used to further identify and rank suggested contacts. If a contact is in a particular group or team within the same organization of the current user, the ranking of that contact, if their group or team is relevant to the identified topic or keyword, can be raised relative to other suggested contacts. For example, if the identified communication is related to an IT issue, then suggested contacts in the current user's organization that are in the IT group will be ranked higher than an individual who may be associated with the topic, but that is not an IT professional. Similarly, the frequency with which particular suggested contacts have been associated with a particular topic can assist in the rankings, both the initial rankings of the semantic index and those used when ranking the set of suggested contacts.

In some instances, the results of the comparison and ranking may include a plurality of suggested contacts. In those instances, the ranked results can be limited for presentation at 425. In some instances, the limit may be a particular presentation threshold. In some instances, the ranking of the suggested contacts may be scored based on the likelihood that the suggested contact can be helpful to the current user. In those instances, only scores exceeding a particular presentation threshold may be returned. In other instances, only a defined maximum number of suggested contacts may be presented. For example, when 50 potential suggested contacts are identified, only the top 5 or 10 may be included in a subset for presentation to the current user. The presentation threshold may be defined by the user, by administrators, by another algorithm, or by any suitable method.

At 430, at least a subset of the ranked results are presented to the current user to identify the suggested communication targets. Those results, as described in 425, may be limited based on some determination. The ranked results can be presented in any suitable manner. In one instance, the results may be shown in an auto-complete or suggestion box associated with a TO or CC field in a new, forwarded, or reply email. In others, a pop-up box or other on-screen presentation can be provided for the presentation. In those situations, the particular suggested contacts may be clickable or interactive, such that clicking or otherwise interacting with the suggestions triggers the opening of a new communication associated with the current issue. In some instances, the new communication may be a different medium than the communication identified at 405. In some instances, presenting the ranked results may include pre-populating a new reply or forward of the identified communication with at least one of the suggested contacts.

In some instances, method 400 may be performed upon initial receipt of a communication such as an email, where the suggested communication targets are prepared prior to the current user opening or viewing the identified communication. In those instances, the system may automatically prepare or otherwise suggest the rankings immediately subsequent to the current user identifying, opening, or otherwise interacting with the identified communication. Alternatively, method 400 could execute when a return communication to the identified communication is initiated. Still further, method 400 may not be started until explicitly requested by the current user, such as in response to a “Suggestion” button being initiated and/or executed. In some instances, method 400 may involve identifying a communication in a first communication medium (e.g., an instant message), and presenting the suggested contacts in a new communication in a second communication medium different than the first (e.g., an email message). This can allow users to respond and communicate in any suitable format, not only the format in which the communication is received or identified.

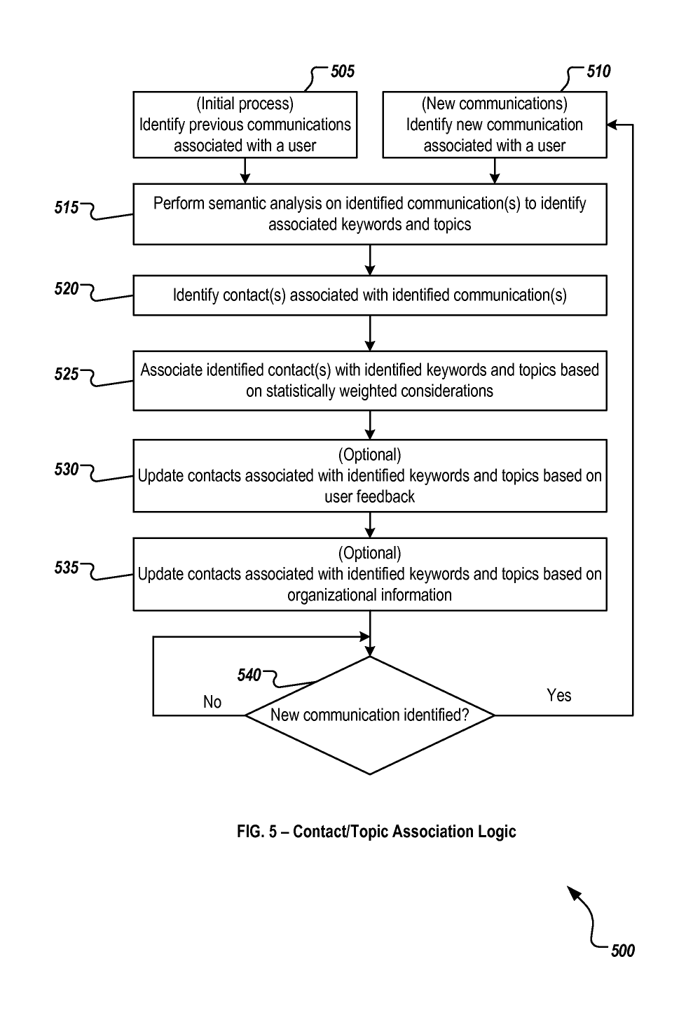

FIG. 5 is a flowchart of an example method 500 for generating indices for use in identifying contextual suggestions of communications targets. For clarity of presentation, the description that follows generally describes method 500 in the context of FIGS. 1 through 3. However, it will be understood that method 500 may be performed, for example, by any other suitable system, environment, software, and hardware, or a combination of systems, environments, software, and hardware as appropriate.

As illustrated, method 500 has two potential boxes where the method can be initiated, 505 and 510. At 505, an initial process may be performed to generate a new semantic index or to update a previously-generated semantic index. At 505, previous communications associated with a user (or set of users) are identified. In a personal solution, the communications may be limited to a single user. In a social or enterprise solution, communications from a plurality of user may be used to generate and/or update the semantic index. Further, the present solution is not limited to communications in the indexing process, but also other relevant documents and information, as described above.

At 515, a semantic analysis is performed on the identified communication(s) to identify one or more keywords and topics associated with the previous communication(s). Any suitable semantic analysis can be performed, and the present solution contemplates using any number of solutions, including a combination of semantic analyses and tools, to perform the described processes. At 520, contact(s) associated with the identified communication(s) and documents are identified. These associated contacts may include persons to whom communications are directed, persons mentioned in the communications and/or documents—including where they are not participants in the communications), or persons otherwise linked to or associated with the communications and/or documents, including through metadata-based connections. In some instances, the associations may be based on an organizational structure or organization-relevant information. At 525, those identified contact(s) are associated with the identified keywords and topics in the semantic index. In some instances, relative strengths of those associations can be defined based on statistically weighted considerations identified during the semantic analysis. These considerations may be based upon a frequency of participation or mentions within the analyzed communications and documents, or how often a contact is included as a recipient or sender on communications related to the topic or keyword.

At 530, method 500 optionally updates contacts and associations with keywords and topics in the semantic index based on user feedback. This may be done in later round-trips based on direct or indirect feedback from users to whom particular contacts were suggested. Associations may be stronger, for example, where users have accepted suggestions for a particular contact, and conversely, weaker where users have rejected suggestions for other particular contacts. In some instances, users may provide explicit feedback indicating whether a particular suggestion was successful or not, thereby modifying the association of the related contact to the keywords or topics of the underlying communication.

At 535, method 500 optionally updates contacts and associations with keywords and topics in the semantic index based on organization information, such as an org chart, directory, or other data. In some instances, the roles of particular contacts may be used to strengthen (or weaken) particular associations, where the roles identify or suggest a specific association to one or more keywords or topics. In some instances, the organizational information may be considered on the initial generation of the semantic index, but not on each update or new communication identification. The organizational information may be re-considered on a periodic basis or in response to an identification that one or more changes are made to the original information.

At 540, a determination is made as to whether a new communication is identified, where the new communication will be used in updating the semantic index. If not, method 500 can end or wait for a new communication. If such a communication is identified, method 500 continues at 510, where the new communication is identified. In some instances, the determination at 540 may not be based on whether a single communication is received, but rather whether a set number of communications are received. In those instances, it may be more resource-friendly to wait until a set number of communications or documents are identified, so as to avoid continuous calls to the semantic analyzer and index. Alternatively, 540 may not be based on new communication(s), but rather on a certain time period or in response to another suitable event.

Upon reaching 510, method 500 can then be performed by updating records to include the new communications. In some instances, method 500 can be initiated when new communication(s) are received, initiating at 510 where an underlying semantic index is already available.

The preceding figures and accompanying description illustrate example processes and computer-implementable techniques. But systems 100, 200, and 300 (or its software or other components) contemplate using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, systems 100, 200, and 300 may use processes with additional operations, fewer operations, and/or different operations, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A method of providing contextual suggestions of communication targets, comprising:
identifying a communication;
semantically analyzing the identified communication to identify at least one keyword or topic associated with the identified communication;
comparing the identified at least one keyword or topic associated with the identified communication to a semantic index of communication targets associated with pre-defined keywords and topics;
identifying a set of communication targets associated with the identified at least one keyword or topic associated with the identified communication; and
presenting the identified set of communication targets as suggested communication targets.

2. The method of claim 1, wherein the identified communication is one of an email, instant message, or short messaging service (SMS) message.

3. The method of claim 1, wherein presenting the identified set of communication targets as suggested communication targets includes:
ranking the identified set of communication targets based on at least one ranking parameter; and
identifying a subset of the relatively higher ranked communication targets.

4. The method of claim 3, wherein only the subset of the relatively higher ranked communication targets are presented.

5. The method of claim 3, wherein the at least one ranking parameter includes at least one of a comparison of the relative location of the communication targets to the recipient of the received communication or a comparison of the relative time zone of the communication targets to the recipient of the received communication.

6. The method of claim 1, wherein the semantic index of communication targets is generated based on a semantic analysis of a plurality of communications and documents of a single user.

7. The method of claim 1, wherein the semantic index of communication targets is generated based on a semantic analysis of a plurality of communications and documents of a plurality of users.

8. The method of claim 7, wherein the semantic index is further generated at least in part based on organizational information associated with at least some users.

9. The method of claim 1, wherein the identified communication is a received communication.

10. The method of claim 9, further comprising, in response to a request to forward or reply to the received communication, populating a recipient field in the forward or reply with at least one of the suggested communication targets.

11. The method of claim 1, wherein semantically analyzing the identified communication includes a semantic analysis of the contents of the identified communication and at least a portion of the metadata associated with the identified communication.

12. The method of claim 1, wherein the identified communication is received in a first communication medium, and wherein presenting the identified set of communication targets as suggested communication targets occurs in a second communication medium different than the first.

13. A system comprising:
one or more computers; and
a computer-readable medium coupled to the one or more computers having instructions stored thereon which, when executed by the one or more computers, cause the one or more computers to perform operations comprising:
identifying a communication;
semantically analyzing the identified communication to identify at least one keyword or topic associated with the identified communication;
comparing the identified at least one keyword or topic associated with the identified communication to a semantic index of communication targets associated with pre-defined keywords and topics;
identifying a set of communication targets associated with the identified at least one keyword or topic associated with the identified communication; and
presenting the identified set of communication targets as suggested communication targets.

14. The system of claim 13, wherein presenting the identified set of communication targets as suggested communication targets includes:
ranking the identified set of communication targets based on at least one ranking parameter; and
identifying a subset of the relatively higher ranked communication targets.

15. The system of claim 14, wherein only the subset of the relatively higher ranked communication targets are presented.

16. The system of claim 14, wherein the at least one ranking parameter includes at least one of a comparison of the relative location of the communication targets to the recipient of the received communication or a comparison of the relative time zone of the communication targets to the recipient of the received communication.

17. The system of claim 13, wherein the semantic index of communication targets is generated based on a semantic analysis of a plurality of communications and documents of a plurality of users, and wherein the semantic index is further generated at least in part based on organizational information associated with at least some users.

18. A computer program product encoded on a non-transitory storage medium, the product comprising non-transitory, computer readable instructions for causing one or more processors to perform operations comprising:
identifying a communication;
semantically analyzing the identified communication to identify at least one keyword or topic associated with the identified communication;
comparing the identified at least one keyword or topic associated with the identified communication to a semantic index of communication targets associated with pre-defined keywords and topics;
identifying a set of communication targets associated with the identified at least one keyword or topic associated with the identified communication;
presenting the identified set of communication targets as suggested communication targets;
ranking the identified set of communication targets based on at least one ranking parameter; and
identifying a subset of the relatively higher ranked communication targets.

19. The computer program product of claim 18, wherein the identified communication is a received communication, where the operations further comprise, in response to a request to forward or reply to the received communication, populating a recipient field in the forward or reply with at least one of the suggested communication targets.

20. The computer program product of claim 18, wherein the identified communication is received in a first communication medium, and wherein presenting the identified set of communication targets as suggested communication targets occurs in a second communication medium different than the first.
